(19) United States
(12) Patent Application Publication
(10) Pub. No.: US 2017/0039570 A1
(43) Pub. Date: Feb. 9, 2017

(54) DETERMINING TRANSACTION RISK FROM SIMILARITY OF PARAMETERS CHARACTERIZING A USER TERMINAL WHICH ORIGINATED A TRANSACTION TO A USER TERMINAL IDENTIFIED FROM THE TRANSACTION

(71) Applicant: CA, INC., New York, NY (US)

(72) Inventors: PRASANNA BABU KRISHNAPPA, Bengaluru (IN); ANAND MANVI, Bengaluru (IN); CHETAN DODDAMANI, Bengaluru (IN); SHASHANKA ARNADY, Bengaluru (IN); ARUN SHETTY, Bengaluru (IN)

(73) Assignee: CA, INC., New York, NY (US)

(21) Appl. No.: 14/817,837

(22) Filed: Aug. 4, 2015

(51) Int. Cl. G06Q 20/40

(52) U.S. Cl. CPC G06Q 20/4016

(57) ABSTRACT

A method of performing operations on a processor of a financial transaction processing system, includes receiving an eCommerce transaction message containing an account identifier for a pending eCommerce transaction and initial parameter information characterizing an originating user terminal that communicated the eCommerce transaction message. A network address of a registered user terminal that is associated with the account identifier is identified. A terminal authentication challenge message containing a request for updated parameters characterizing the registered user terminal, is communicated toward the network address. A terminal authentication response message containing updated parameter information characterizing the registered user terminal, is received from the registered user terminal. A risk score for the pending eCommerce transaction is generated based on similarity between the initial and updated parameter information. Processing of the eCommerce authentication request is controlled based on the risk score. Related methods of performing operations on a user terminal are disclosed.

### BACKGROUND

The present disclosure relates to transaction risk processing systems.

Financial transactions relating to purchasing goods and services are predominately paid for using credit accounts and debit accounts that an account owner accesses through associated credit cards and debit cards. Financial transaction processing systems provide verification processes that allow merchants to verify that account information is valid and the account owner has sufficient credit or debit funds to cover the purchase.

When a purchaser is located at the merchant's facility, the merchant is responsible for authenticating that the purchaser is the account owner by, for example, comparing the purchaser's signature to an existing signature on the card, examining a picture ID of the purchaser, or providing a password.

For purchases made through a merchant's website and other electronic commerce (“eCommerce”) transactions (known as a card-not-present transactions (CNP)), financial transaction processing systems can use eCommerce authentication processes that challenge the purchaser to provide a security code that is used to authenticate that the purchaser is the account owner or is otherwise authorized by the account owner. The security code may be password, personal identification number (PIN), or other information known to the account owner such as a one time password received through e-mail, etc. Purchasers can find eCommerce authentication processes undesirable due to the need to remember security codes and the requirement to successfully complete additional process steps for purchases. Merchants can find eCommerce authentication processes undesirable because of the fees charged for use of such processes and lost sales due to purchasers abandoning transactions during the eCommerce authentication processes.

### SUMMARY

Some embodiments disclosed herein are directed to a method of performing operations on a processor of a user terminal. The method includes, responsive to initiation of an eCommerce transaction, generating initial parameter information characterizing the user terminal and communicating toward a financial transaction processing system an eCommerce transaction message containing an account identifier and the initial parameter information. The method further includes, responsive to receipt of a terminal authentication challenge message from the financial transaction processing system, generating updated parameter information characterizing the user terminal and communicating toward the financial transaction processing system a terminal authentication response message containing the updated parameter information.

Some other embodiments disclosed herein are directed to a method of performing operations on a processor of a financial transaction processing system. The method includes receiving an eCommerce transaction message containing an account identifier for a pending eCommerce transaction and initial parameter information characterizing an originating user terminal that communicated the eCommerce transaction message. A network address of a registered user terminal that is associated with the account identifier is identified. A terminal authentication challenge message containing a request for updated parameters characterizing the registered user terminal, is communicated toward the network address. A terminal authentication response message containing updated parameter information characterizing the registered user terminal, is received from the registered user terminal. A risk score for the pending eCommerce transaction is generated based on similarity between the initial parameter information and the updated parameter information. Processing of the eCommerce authentication request is controlled based on the risk score.

Other methods, user terminals, and components of financial transaction processing system according to embodiments will be or become apparent to one with skill in the art upon review of the following drawings and detailed description. It is intended that all such additional methods, user terminals, and components of financial transaction processing system be included within this description and protected by the accompanying claims.

### BRIEF DESCRIPTION OF THE DRAWINGS

Aspects of the present disclosure are illustrated by way of example and are not limited by the accompanying drawings. In the drawings:

FIG. 1 is a combined flowchart and data flow diagram of a financial transaction processing system that is configured to process eCommerce transactions from user terminals is accordance with some embodiments;

FIG. 2 is a block diagram of an example configuration of the financial transaction processing system of FIG. 1, which includes an authentication gateway node that controls which eCommerce authentication requests are selected for authentication by an authentication node, in accordance with some embodiments;

FIGS. 3A, 3B and 4 are flowcharts that illustrate operations that may be performed by a user terminal to perform an eCommerce transaction through a financial transaction processing system in accordance with some embodiments.

FIGS. 5-7 are flowcharts that illustrate operations that may be performed by a financial transaction processing system and, more particularly, by an authentication gateway node to control processing of eCommerce transaction requests from user terminals, in accordance with some embodiments; and

FIG. 8 is a block diagram of a computer system that may be incorporated into the authentication gateway node, the user terminal, and/or other components of the system of FIG. 1 in accordance with some embodiments.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

The rate of fraud occurring with eCommerce transactions continues to increase with the increasing number of various types of user terminals (e.g., smart phones, portable computing devices, etc.) that are used to conduct eCommerce transactions. Reliance on a user terminal identifier associated with an eCommerce transaction is not sufficient to prevent fraud, because a fraudster can perform a fraudulent eCommerce transaction by configure a user terminal to provide a user terminal identifier that is known to be associated with an account owner but different from the identifier for the user terminal operated by the fraudster. Various embodiments of the present disclosure provide an extra level of security to identify such fraudulent eCommerce transactions.

Some embodiments of the present disclosure are directed to a financial transaction processing system that determines the risk of an eCommerce transaction based on comparing similarity between parameter information it receives with an eCommerce transaction message and other parameter information it subsequently receives responsive to a request provided to a user terminal that is registered as being associated with an account involved in the eCommerce transaction. Initially received parameter information characterizes an originating user terminal that generated the eCommerce transaction message and subsequently received updated parameter information characterizes the registered user terminal that is queried using a network address associated with an account identifier contained in the eCommerce transaction message. As will be explained below, the initial and updated parameter information may be generated based on user terminal sensor readings, user terminal hardware characteristics, and/or user terminal software characteristics. The time variant characteristics of a user terminal which are selected for reporting can be selected so that the initial parameter information will have a threshold level of similarity to the updated parameter information when both are generated by a same user terminal and, in contrast, will have less than the threshold level of similarity when the initial parameter information is generated by a different user terminal from that which generated the updated parameter information. In this manner, a user terminal which is operated by a fraudster can be distinguished form a registered user terminal which is registered as associated with the account identifier. A risk score is generated based on the similarity, and processing of the eCommerce transaction is controlled based on the risk score.

When the initial parameter information and the updated parameter information have at least a threshold level of similarity between them, the originating user terminal and the registered user terminal are determined be the same terminal and the risk score is generated to indicate a low level of risk. In sharp contrast, when the initial parameter information and the updated parameter information have less than the threshold level of similarity between them, the originating user terminal and the registered user terminal are determined be different user terminals and the risk score is generated to indicate a high level of risk.

Controlling the processing of the eCommerce transaction based on the risk score can include selecting between triggering authentication and precluding authentication of a purchaser based on the risk score and/or selecting between allowing and denying the eCommerce transaction based on the risk score.

For example, authentication of a purchaser who initiated the pending eCommerce transaction may be performed by an authentication node responsive to the risk score indicating the high level of risk. In contrast, authentication of a purchaser who initiated the pending eCommerce transaction may be precluded from being performed by the authentication node responsive to the risk score indicating the low level of risk.

An eCommerce transaction can be any type of financial transaction that involves transmitting funds or data over an electronic data network, such as the Internet.

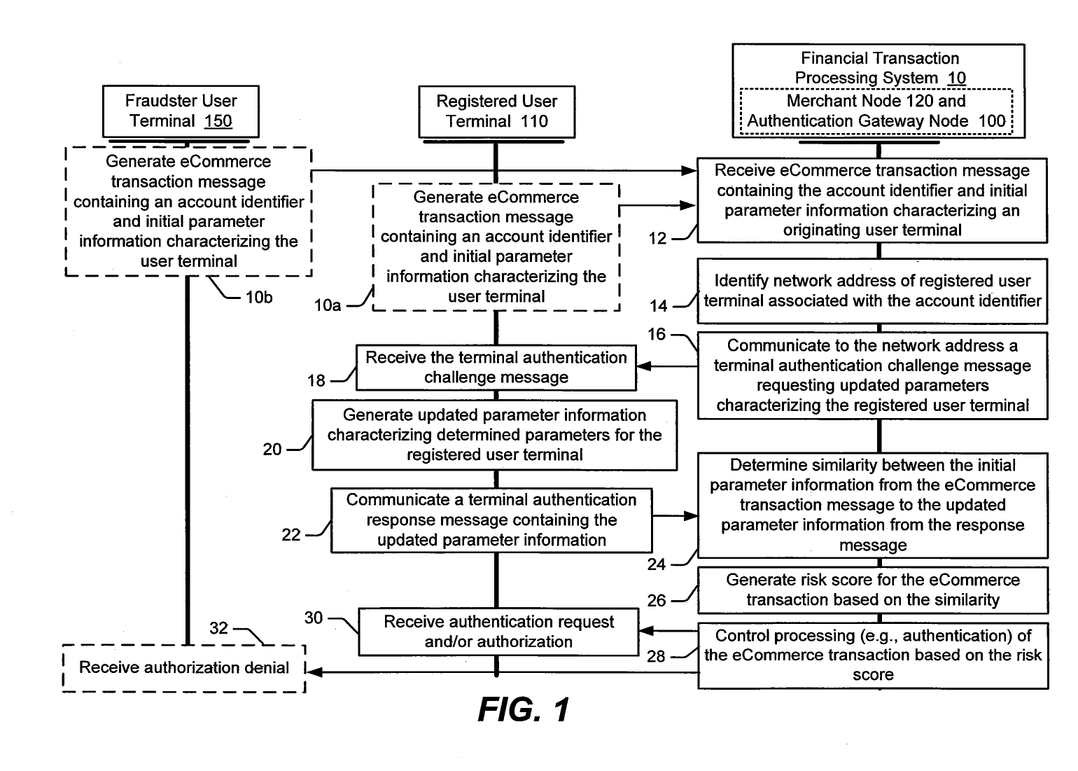

FIG. 1 is a combined flowchart and data flow diagram of a financial transaction processing system 10 that is configured to process eCommerce transactions from user terminals 110 in accordance with some embodiments. Referring to FIG. 1, a purchaser, who may be the owner of an account which will be charged for an eCommerce transaction, can operate a web browser and/or application executed by a user terminal 110 to select items to be purchased and generate (block 10a) an eCommerce transaction message that is communicated to the system 10. The eCommerce transaction message contains an account identifier (e.g., credit card number and/or debit card number), and may furthermore contain an identifier for the user terminal 110. The user terminal 110 may be any electronic device that can communicate with the system 10, including, but not limited to, a tablet computer, desktop computer, laptop computer, mobile phone, etc.

eCommerce transaction messages may unfortunately also be generated (block 10b) by another user terminal 150 which is operated by a fraudster. As explained above, a fraudster can configure the user terminal 150 to generate an eCommerce transaction containing the account identifier and an identifier that is the same as the identifier of the user terminal 110. Reliance on a user terminal identifier associated with an eCommerce transaction to determine whether an eCommerce transaction is originating from a user terminal operated by an owner of the account is therefore not sufficient to prevent fraud.

In accordance with at least some embodiments, the eCommerce transaction message contains an account identifier (e.g., credit card number and/or debit card number) and initial parameter information which characterizes the registered user terminal 110. As will be explained in further detail below, the initial parameter information characterizing the registered user terminal 110 may include a measurement of a time variant characteristic by a sensor associated with the user terminal 110, hardware characteristics determined for the user terminal 110, and/or software characteristics determined for the user terminal 110.

The system 10 receives (block 12) the eCommerce transaction message containing the account identifier for the pending eCommerce transaction and the initial parameter information characterizing the user terminal 110. The system 10 identifies (block 14) a network address of the user terminal 110 associated with the account identifier. When the eCommerce transaction message was generated by the user terminal 110 associated with the account identifier, the network address identified based on the account identifier is the network address of the user terminal 110. However, in sharp contrast, when the eCommerce transaction message was generated by the fraudster's user terminal 150, the network address identified based on the account identifier is different from the network address of the fraudster's user terminal 150.

The system 10 communicates (block 16) toward the network address, a terminal authentication challenge message containing a request for updated parameters characterizing the registered user terminal. Irrespective of whether the e-commerce transaction message was generated by the fraudster's user terminal 150 or the account owner's user terminal 110, the network address is determined based on the account identifier so that the terminal authentication challenge message is received (block 18) by the user terminal 110. In some embodiments, the system 10 has registered a terminal identifier and network address for the user terminal 110 with an association to an account identifier for the account. The eCommerce transaction message can include the account identifier and a terminal identifier for the originating user terminal 110/150. The system 10 uses the received terminal identifier to identify the network address for use in sending the authentication challenge message.

A component of the system 10 may establish an encrypted persistent IP communication connection(s) with the user terminal(s). The eCommerce transaction message and the terminal authentication response message can then be separately communicated through the encrypted persistent IP communication connection(s). The encrypted persistent IP communication connection may be generated using mechanisms such as Apple Push Notification Service, Google Cloud Messaging Service, Amazon Simple Notification Service, and/or Windows Push Notification Service.

Responsive to receipt of the terminal authentication challenge message, the user terminal 110 generates (block 20) updated parameter information characterizing the user terminal 110, and communicates (block 22) toward the system 10 a terminal authentication response message containing the updated parameter information.

The system 10 receives the terminal authentication response message and determines (block 24) similarity between the initial parameter information and the updated parameter information. The system 10 generates (block 26) a risk score for the pending eCommerce transaction based on similarity between the initial parameter information and the updated parameter information. The system 10 then controls (block 28) processing of the eCommerce authentication request based on the risk score. The system 10 may communicate a message that is received (block 30) by the user terminal 110 which, based on the processing controls used by the system 10, asks the purchaser to complete an authentication challenge or notifies the purchaser that the eCommerce transaction has been allowed or denied, etc. When the eCommerce transaction message originated from the fraudster's user terminal 150, the system 10 may communicate a message that is received (block 32) by the user terminal 150 which notifies the purchaser that the eCommerce transaction has been denied.

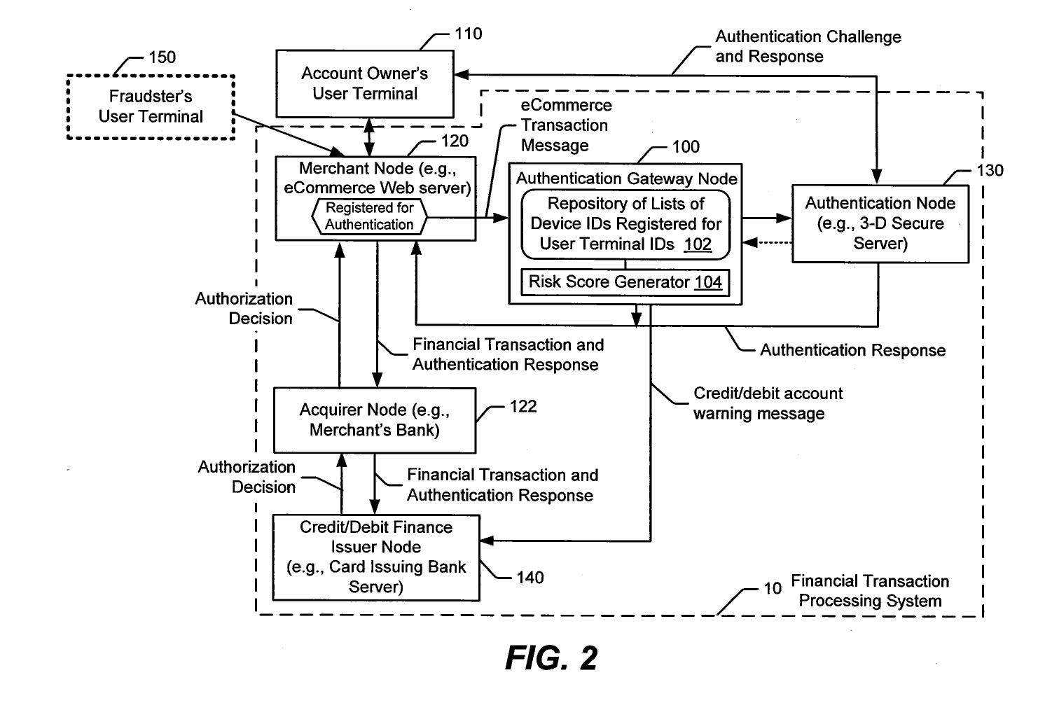

Some further embodiments are directed to using the risk score to control whether authentication is performed on a purchaser. FIG. 2 is a further example block diagram of the financial transaction processing system 10. In the embodiments of FIG. 2, the system 10 includes an authentication gateway node 100 that receives eCommerce transaction messages from merchant nodes 120 (e.g., merchants' eCommerce Web servers), and controls which of eCommerce authentication requests are authenticated by an authentication node 130. Although some embodiments are described in the context of authenticating credit card and/or debit card transactions for purchases made through a merchant node 120, the embodiments disclosed herein are not limited thereto and can be used with other types of authentication processes.

The eCommerce transaction message is communicated from the owner's user terminal 110 and/or from the fraudster's user terminal 150 to the merchant node 120. Because an eCommerce transaction message can originate from the owner's user terminal 110 or from the fraudster's user terminal 150, the user terminal is also referenced as 110/150 to refer to the multiple possible sources of the eCommerce transaction message. In accordance with at least some embodiments, the eCommerce transaction message contains an account identifier (e.g., credit card number and/or debit card number) and initial parameter information which characterizes the user terminal 110/150.

Because of the prevalence of fraud occurring in eCommerce and other card-not-present financial transactions, where merchants cannot directly authenticate purchasers using picture IDs, electronic authentication processes have been introduced to authenticate purchasers. Electronic authentication processes can be performed by the authentication node 130 to attempt to confirm that the purchaser is an account owner or is otherwise authorized by the account owner. If the merchant node 120 is registered for use of electronic authentication processes, the merchant node 120 communicates the eCommerce transaction message, which may be the same as or based on the eCommerce transaction message received from the user terminal 110/150. The eCommerce transaction message communicated from the merchant node 120 to the authentication gateway node 100 contains the account identifier and the initial parameter information, and may furthermore contain any one or more of the following: cardholder's name; account verification information; expiration date for the card; card verification value (CVV); cardholder's mailing address; and purchaser's shipping address.

The merchant node 120 communicates the eCommerce transaction message toward the authentication node 130 for authentication processing to authenticate the purchaser. The merchant node 120 may communicate the eCommerce transaction message using a software plug-in provided by a provider of the authentication node 130. Authentication of the purchaser can include determining whether the purchaser possesses secret information that should only be known to the account owner or another person who has been authorized by the account owner to make purchases using the account.

As will be explained in further detail below, the authentication gateway node 100 controls which eCommerce transaction message from the merchant node 120 and other merchant nodes 120 trigger authentication of purchasers. The authentication gateway node 100 may also generate a credit/debit account warning message which notifies a credit/debit finance issuer node 140 (e.g., card issuing bank server) that privileges with an account should be halted/frozen (e.g., cancel card) or otherwise modified.

The authentication gateway node 100 may intercept or otherwise receive the eCommerce transaction message from the merchant node 120 and determine whether authentication will be performed by the authentication node 130. The authentication gateway node 100 may, for example, selectively either route the eCommerce transaction message to the authentication node 130 for authentication or respond to the merchant node 120 without authentication by the authentication node 130 (e.g., some eCommerce authentication requests bypass the authentication node 130). Alternatively, the authentication gateway node 100 may mark the eCommerce transaction messages to indicate whether it is to be authenticated by the authentication node 130 (e.g., all eCommerce transaction messages flow through the authentication node 130 but only some cause authentication). These and other operations by the authentication gateway node 100 are described in further detail below.

Pursuant to one type of authentication process, the authentication node 130 communicates an authentication challenge message to the user terminal 110/150 which requires the purchaser to enter a security code to complete the purchase. The entered security code is returned to the authentication node 130 in a response message. The security code may be a password, personal identification number (PIN), electronic security token, or other secret information known to the account owner.

The authentication node 130 can compare the security code to an expected code, and apply one or more rules which may be defined by the card issuing bank (referred to more generally as the credit/debit finance issuer node 140 below) to generate an authentication response (e.g., authentication response code) that indicates an outcome of the authentication process.

One type of authentication process is known as a 3-D Secure protocol that can be performed by the authentication node 130 operating as a 3-D Secure authentication server. The 3-D Secure protocol was developed by financial card associations, including Visa and MasterCard, and has become an industry standard. The protocol uses XML messages sent over secure socket layer (SSL) connections between the user terminal 110/150 and the authentication node 130, which can also be referred to as an access control server (ACS). The authentication challenge can be presented through the user terminal 110/150 to the purchaser within the same web browser window as an in-line session (referred to as an inframe authentication session) or can be presented in a separate window (e.g., pop-up window).

An advantage to merchants of using purchaser authentication is a reduction in “unauthorized transaction” chargebacks. A disadvantage to merchants is that they pay a software setup fee, monthly fee, and per-authentication fee for use of the 3-D Secure access control server provided by the authentication node 130. Moreover, 3-D Secure operation can be complicated and create transaction failures.

Some purchasers view the additional authentication steps as a nuisance or obstacle to completing transactions and/or they erroneously interpret the authentication challenge (e.g., pop-up window) as originating from a fraudulent phishing site/process, which can result in a substantial increase in transaction abandonment by the purchaser and lost revenue to merchants. Some 3-D Secure authentication processes require the purchaser to complete an authentication registration process for the cardholder's financial account, including agreeing to all terms and conditions presented by 3-D Secure, before the purchaser can proceed with a purchase. Purchasers who are unwilling to undertake the risk or inconvenience of registering their card during a purchase, are forced to abandon the transaction. Moreover, some user terminals, such as those having mobile web browsers, can lack features (e.g., support for window frames and/or pop-ups) necessary for proper operation of a 3-D Secure authentication process.

For these and other reasons, some embodiments disclosed herein are directed to the authentication gateway node 100 generating risk scores for eCommerce transaction messages based on similarity between parameter information it receives with an eCommerce transaction message and other parameter information it subsequently receives responsive to a terminal authentication challenge message that it sends to a network address (i.e., for the user terminal 110) that has been registered as associated with an account identifier that is used for paying for the eCommerce transaction.

The authentication gateway node 100 receives the eCommerce transaction message containing the account identifier for the pending eCommerce transaction and the initial parameter information characterizing the user terminal 110/150. The authentication gateway node 100 identifies a network address of the user terminal 110 associated with the account identifier. When the eCommerce transaction message was generated by the user terminal 110 associated with the account identifier, the network address identified based on the account identifier is the network address of the user terminal 110. However, in sharp contrast, when the eCommerce transaction message was generated by the fraudster's user terminal 150, the network address identified based on the account identifier is different from the network address of the fraudster's user terminal 150.

The authentication gateway node 100 communicates toward the network address, a terminal authentication challenge message containing a request for updated parameters characterizing the registered user terminal. Irrespective of whether the e-commerce transaction message was generated by the fraudster's user terminal 150 or the account owner's user terminal 110, the network address causes the terminal authentication challenge message to be received by the user terminal 110.

Responsive to receipt of the terminal authentication challenge message, the user terminal 110 generates updated parameter information characterizing the user terminal 110, and communicates toward the authentication gateway node 100 a terminal authentication response message containing the updated parameter information.

The authentication gateway node 100 receives the terminal authentication response message and generates a risk score for the pending eCommerce transaction based on similarity between the initial parameter information and the updated parameter information. The authentication gateway node 100 may use further information when generating the risk score. In one embodiment, the risk score is generated based on comparison of the reported list of wireless device identifiers to the registered list of wireless device identifiers, and further based on a financial account identifier, a transaction amount, an expiration date for a card associated with the financial account identifier, a verification value, and a cardholder's name contained in the eCommerce authentication request. Additional or other information may be used when generating the risk score in accordance with various embodiments disclosed herein.

The authentication gateway node 100 then controls authentication of the eCommerce authentication request based on the risk score. The authentication gateway node 100 may communicate an authentication challenge message and/or authorization message to the user terminal 110/150 from which the eCommerce transaction request was generated.

The authentication gateway node 100 can be configured to operate on eCommerce authentication requests in-flight before being delivered to the authentication node 130, and control, based on the risk scores, which of the eCommerce authentication requests are processed by the authentication node 130 for authentication of purchasers and generation of authentication responses based on the outcomes of the authentication.

In one embodiment, only eCommerce authentication requests having risk scores that satisfy a defined rule are provided to the authentication node 130 for authentication processing and generation of the authentication responses based on the authentication processing, while other eCommerce authentication requests (having risk scores that do not satisfy the defined rule) bypass authentication processing by the authentication node 130. When bypassing authentication processing by the authentication node 130, the authentication gateway node 100 may generate an authentication response based on the risk score for the eCommerce authentication request (e.g., generate an authentication response indicating that the purchaser was properly authenticated) and communicate the authentication response to the merchant node 120 as if it had originated from the authentication node 130. When the authentication response is generated by the authentication gateway node 100, it may contain the same or similar content to an authentication response generated by the authentication node 130 so that the merchant node 120 is not aware that the authentication response was generated without authentication of the purchaser being performed by the authentication node 130.

When selectively providing the eCommerce authentication request to the authentication node 130, the authentication gateway node 100 may selectively mark the eCommerce authentication request to indicate whether authentication of the purchaser by the authentication node 130 is requested based on whether the risk score satisfies a defined rule. The authentication gateway node 130 then performs authentication processing (e.g., providing authentication challenges to purchasers) for only the eCommerce authentication requests that are marked for authentication. The authentication gateway node 130 can then generate the authentication responses based on a result of the authentication processing when performed, or based on the risk score when authentication processing is not performed.

In another embodiment, when selectively providing the eCommerce authentication request to the authentication node 130, the authentication gateway node 100 selectively routes the eCommerce authentication request to the authentication node 130 for authentication of the purchaser based on whether the risk score satisfies a defined rule. Accordingly, the authentication node 130 performs purchaser authentication processes for each eCommerce authentication request that it receives, however the authentication node 130 only receives eCommerce authentication requests having risk stores that the authentication gateway node 100 determined to satisfy a defined rule (e.g., having a risk score that exceeds a threshold level or alternatively that does not exceed a threshold level).

In another embodiment, the authentication node 130 can include some of the functionality described herein of the authentication gateway node 100. The authentication node 130 can receive all eCommerce authentication requests, but selectively generate an authentication challenge to the user equipment 110/150 (FIG. 1) to authenticate the purchaser only for eCommerce authentication requests having risk scores that satisfy a defined rule.

Depending upon the risk score, the authentication gateway node 100 may generate a credit/debit account warning message which notifies the credit/debit finance issuer node 140 (e.g., card issuing bank server) that privileges with an account should be halted/frozen (e.g., cancel card) or otherwise modified.

Although the authentication gateway node 100 is shown as being separate from the merchant node 120, in some embodiments the authentication gateway node 100 is incorporated into the credit/debit finance issuer node 140 or the merchant node 120 so that at least some of the operations disclosed herein as being performed by the authentication gateway node 100 are performed within the credit/debit finance issuer node 140 or the merchant node 120. Thus for example, the risk scores can be generated internal to the merchant node 120 and used to control when eCommerce authentication requests are communicated to the authentication node 130. The merchant node 120 can use the risk score to selectively send an eCommerce authentication request to the authentication node 130 for authentication of the purchaser when the risk score satisfies a defined rule or send the financial transaction to the acquirer node 122 and credit/debit finance issuer node 140 for verification against the cardholder's account without authentication of the purchaser by the authentication node 130 when the risk score does not satisfy a defined rule.

Similarly, although the authentication gateway node 100 is shown as being separate from the authentication node 130, in some embodiments the authentication gateway node 100 is incorporated into the authentication node 130 so that at least some of the operations disclosed herein as being performed by the authentication gateway node 100 are performed within the authentication node 130. Thus for example, the risk scores can be generated internal to the authentication node 130 and used to control which of the eCommerce authentication requests cause authentication challenges to be generated to purchasers.

The authentication response (e.g., 3-D Secure authentication response code) can be generated by the authentication node 130, based on authentication processes performed with the purchaser and/or may be generated by the authentication gateway node 100 based on the risk score (e.g., without authentication processing by the authentication node 130) and provided to the merchant node 120. The merchant node 120 receives the authentication response and may deny the transaction based on content of the authentication response (e.g., based on the risk score generated by the authentication gateway node 100 and/or based on the result of authentication processes by the authentication node). The merchant node 120 can initiate verification of the transaction by communicating to a credit/debit finance issuer node 140, via an acquirer node 122 (e.g., merchant's bank), the authentication response and content of the eCommerce authentication request (e.g., cardholder information, other content of an eCommerce authentication request disclosed herein, etc).

The acquirer node 122 routes the authentication response and the content of the eCommerce authentication request to a credit/debit finance issuer node 140 (e.g., card issuing bank server such as a Visa or other card server via VisaNet, BankNet, etc.). The credit/debit finance issuer node 140 generates an authorization decision based on whether the account identifier has a sufficient credit limit and/or existing funds to cover the amount of the financial transaction, and can further generate the authorization decision based on the authentication response from the authentication node 130 and/or the authentication gateway node 100.

The credit/debit finance issuer node 140 communicates its authorization decision to the acquirer node 122, which communicates an authorization decision to the merchant node 120. The merchant node 120 decides whether to complete the transaction with the purchaser or to deny the transaction based on the authorization decision from the acquirer node 122.

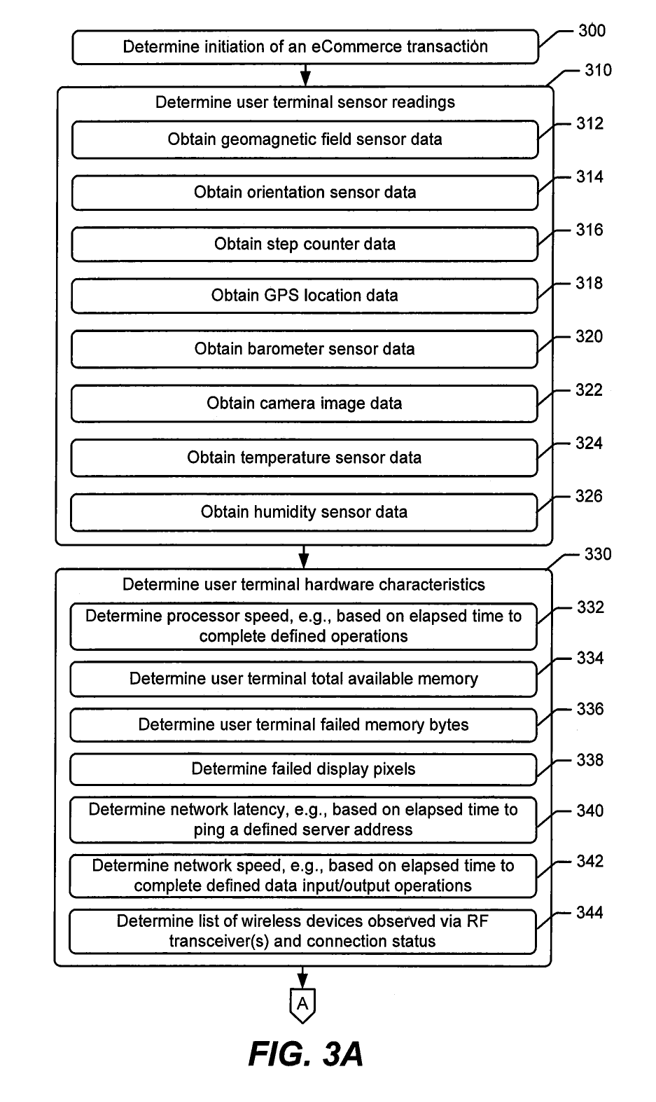

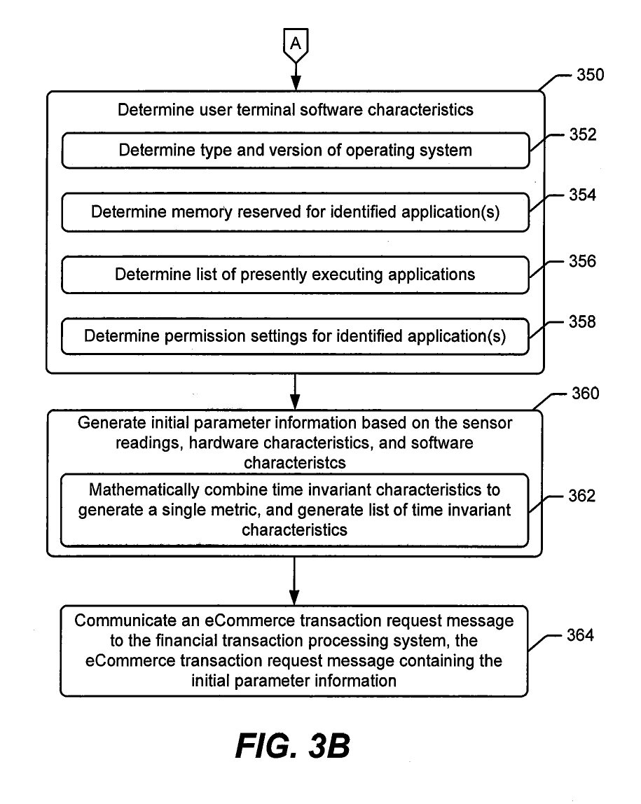

FIGS. 3A, 38 and 4 are flowcharts that illustrate operations that may be performed by a user terminal to perform an eCommerce transaction through the financial transaction processing system 10 in accordance with some embodiments.

Referring to FIG. 3A, the user terminal determines (block 300) that an eCommerce transaction is being initiated and, responsive thereto, performs one or more of: determining (block 310) sensor readings of the user terminal; determining (block 330) hardware characteristics of the user terminal; and determining (block 350) software characteristics of the user terminal. The user terminal then generates (block 360) initial parameter information based on the determined sensor readings, hardware characteristics, and/or software characteristics. The user terminal communicates (block 364) an eCommerce transaction request message to a financial transaction processing system. The eCommerce transaction request message contains the initial parameter information.

In some embodiments, the user terminal determines (block 310) sensor readings for the user terminal by performing one or more of: obtaining (block 312) geomagnetic field sensor data from a geomagnetic sensor; obtaining (block 314) physical orientation data from an orientation sensor within the user terminal; obtaining (block 316) step count data from a step counter (e.g., movement sensor coupled to a step counter program executed by a processor) within the user terminal; obtaining (block 218) global positioning system (GPS) location data from a GPS sensor; obtaining (block 320) barometric pressure data from a barometric sensor; obtaining (block 322) image data from a camera; obtaining (block 324) picture data from a temperature sensor; and obtaining (block 326) humidity data from a humidity sensor.

Because sensors for the fraudster's user terminal 150 will likely output different data than corresponding types of sensor for the account owner's user terminal 110, the parameter information generated from the sensors will be different between the user terminals 110 and 150. The various defined sensors may be located within the user terminal or may be communicatively connected to the user terminal. For example, the user terminal may obtain temperature data, humidity data, and/or barometric pressure data from a network server that is queried using a geographic location of the user terminal to obtain current data for that location.

The user terminal may determine a hardware characteristic of the user terminal based on determining (block 332) speed of a processor of the user terminal. The user terminal may measure an elapsed time for the processor to complete execution of a defined set of operations, and generate the parameter information based on the elapsed time. Because the processor speed of the user terminal will depend on processor clock rate, processor architecture, memory read/write speed, and processor device fabrication process variations which result in speed differences between any two processors manufactured from the same fabrication line, the processor speed determined for the fraudster's user terminal 150 will be different from the processor speed determined for the account owner's user terminal 110, so that the parameter information will be different between the user terminals 110 and 150.

The user terminal may generate the parameter information based on determining (block 334) the total available memory in the user terminal and/or based on the determining (block 336) the number of failed memory bytes in a memory of the user terminal. Thus, for example, an application executed by the user terminal may identify failed memory bytes and count the number of failed memory bytes, or may obtain that count from another circuit or application. Because the number of failed memory bytes in a memory of the fraudster's user terminal 150 will be different from the number of failed memory bytes in a memory of the account owner's user terminal 110, the parameter information will be different between the user terminals 110 and 150.

The user terminal may generate the parameter information based on determining (block 338) the number of failed display pixels in a display device of the user terminal. Because the number of failed display pixels in a display device of the fraudster's user terminal 150 will likely be different from the number of failed display pixels in a display device of the account owner's user terminal 110, the parameter information will be different between the user terminals 110 and 150.

The user terminal may generate the parameter information based on determining (block 340) network latency, which may be determined based on measuring network communication latency for a communication between the user terminal and a defined server address through a network. The user terminal may, for example, ping a defined network server. Because the physical distance over which the message propagates from the user terminal to the server and the number of forwarding nodes in the network between the user terminal to the server will be different for the message from the fraudster's user terminal 150 compared to the message from the account owner's user terminal 110, the parameter information will be different between the user terminals 110 and 150.

The user terminal may generate the parameter information based on determining (block 342) network speed, which may be determined based on measuring elapsed time to complete a defined data input and/or output operations with a defined network server. Again, because the physical distance over which the data propagates between the user terminal and the server and the number of forwarding nodes in the network will be different for the data input/output with the fraudster's user terminal 150 compared to the data input/output with the account owner's user terminal 110, the parameter information will be different between the user terminals 110 and 150.

The user terminal may generate the parameter information based on determining (block 344) a list of wireless device identifiers of wireless devices that are observed by the user terminal through one or more wireless transceiver interfaces of the user terminal. The list may include wireless device identifiers of wireless devices that art observable through any type of wireless communication technology by the user terminal. In one example embodiment, the list of wireless device identifiers can include a list of Bluetooth devices that indicated to have established a traffic data connection through completing pairing to the user terminal, but may alternatively or additionally list Bluetooth devices that are not paired to the user terminal but are presently observed to be within communication range of a Bluetooth transceiver of the user terminal through operations for discovering Bluetooth devices. In another example embodiment, the list of wireless device identifiers can include a list of wireless local area network, WLAN, (e.g., WIFI) devices that are indicated to have established a traffic data connection with the user terminal through joining a shared network that includes the user terminal (e.g., WIFI shared network or WIFI Direct), but may alternatively or additionally list WLAN devices that are not connected to the user terminal but which have been discovered to be within communication range of a WLAN transceiver of the user terminal through operations for discovering WLAN routers and other devices. Because the lists of wireless device identifiers observed by the user terminals 110 and 150 will likely be different, the parameter information will be different between the user terminals 110 and 150.

Referring to the continuing flowchart of FIG. 3B, the user terminal generates the parameter information based on determining (block 350) a software characteristic of the user terminal based on any one or more of: determining (block 352) a type and version of an operating system executed by the user terminal; determining (block 354) an amount of memory reserved for use by one or more identified applications; determining (block 356) a list of presently executing applications by the user terminal and/or determining a list of applications that are stored in nonvolatile memory of the user terminal and/or available for execution, and determining (block 358) permission settings for one or more identified applications.

In one example embodiment, the user terminal generates the parameter information as a list of applications stored in the user terminal and the permission settings that have been defined for each of those applications. The permission settings that can be determined for an application based on whether the application has been granted access to any one or more of the following: permission to access camera data from camera, permission to access audio data from a microphone, permission to write data to a defined external interface of the user terminal, permission to read data from a defined external interface of the user terminal, permission to access sensor data from a defined sensor of the user terminal, permission to be informed when the user terminal becomes unlocked, permission to access the Internet, permission to access geolocation information of the user terminal, etc.

The user terminal generates (block 360) initial parameter information based on the sensor data, hardware characteristics, and/or software characteristics, and may mathematically combine (block 362) the determined characteristics and/or sensor data. The user terminal then communicates (block 364) an eCommerce transaction request message to the financial transaction processing system 10, where the eCommerce transaction request message contains the initial parameter information.

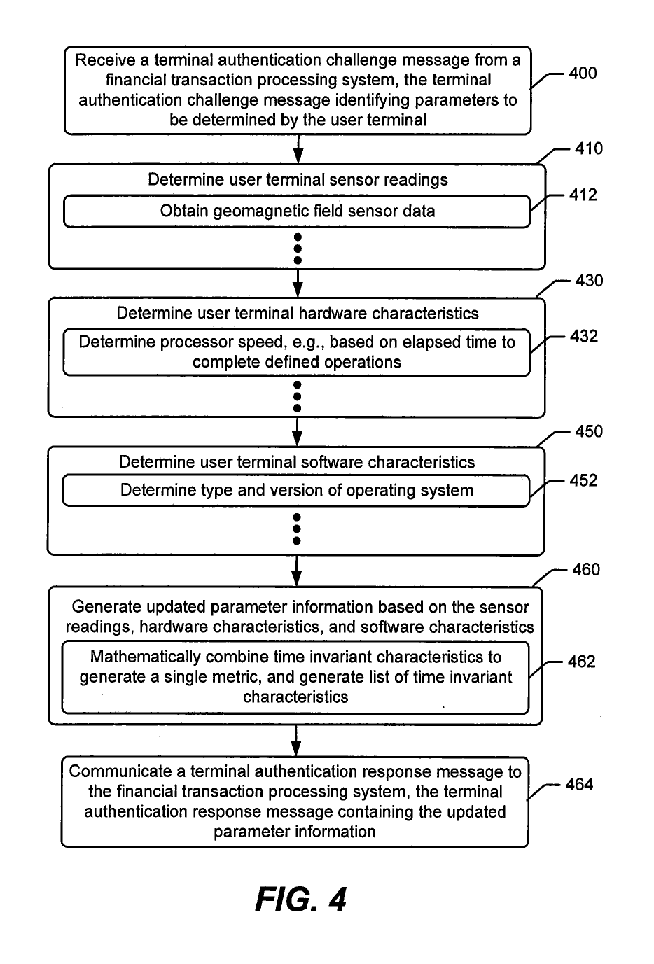

FIG. 4 illustrate further operations that may be performed by a user terminal responsive to receiving (block 400) a terminal authentication challenge message from the financial transaction processing system 10, e.g., block 18 in FIG. 1. The terminal authentication challenge message may identify parameters that are to be determined by the user terminal. As explained above, the terminal authentication challenge message is received by a user terminal having a network address that has been registered with the financial transaction processing system 10 as being associated with the account identifier. The user terminal performs one or more of: determining (block 410) sensor readings of the user terminal; determining (block 430) hardware characteristics of the user terminal; and determining (block 450) software characteristics of the user terminal. The user terminal then generates (block 460) updated parameter information based on the determined sensor readings, hardware characteristics, and/or software characteristics, and may mathematically combine (block 462) one or more of those characteristics to generate the updated parameter information. The user terminal communicates (block 464) an eCommerce transaction request message to a financial transaction processing system. The eCommerce transaction request message contains the updated parameter information.

The user terminal may determine (block 410) the sensor readings based on the operations described above for block 310 and, more particularly, based on one or more of the operations described for blocks 312-326. The user terminal may determine (block 430) the hardware characteristics of the user terminal based on the operations described above for block 330 and, more particularly, based on one or more of the operations described for blocks 332-344. The user terminal may determine (block 450) the software characteristics of the user terminal based on the operations described above for block 350 and, more particularly, based on one or more of the operations described for blocks 352-358.

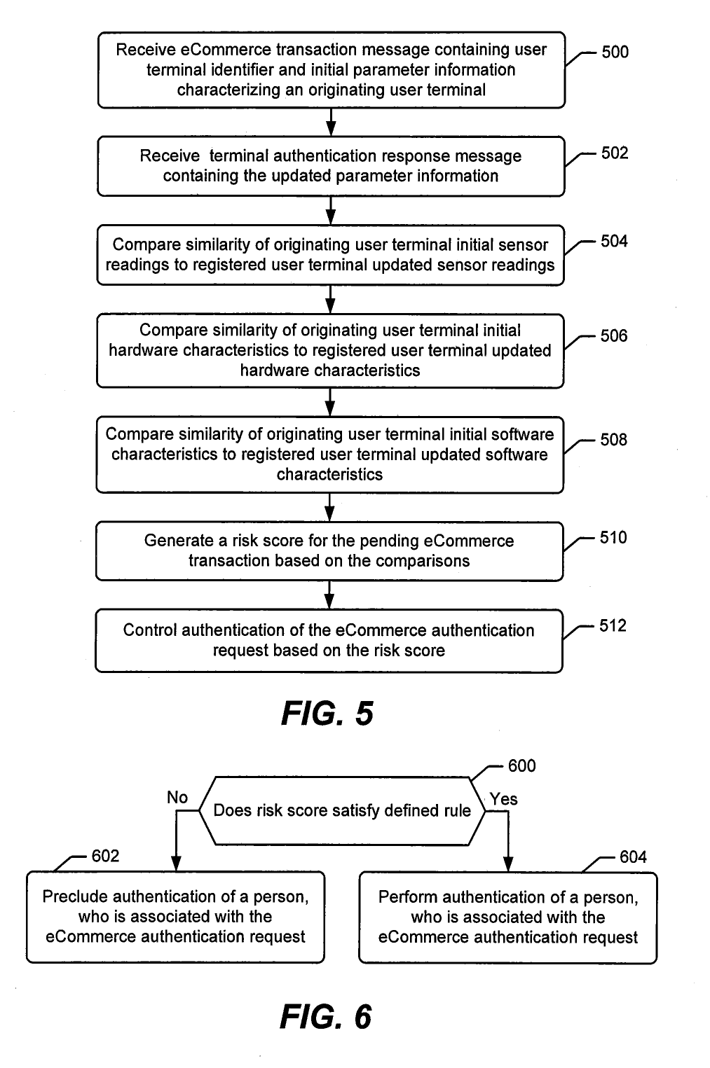

FIGS. 5-7 are flowcharts that illustrate operations that may be performed by the financial transaction processing system 10 and, more particularly, by an authentication gateway node 100 to control processing of eCommerce transaction requests from user terminals, in accordance with some embodiments. Referring to FIG. 5, the system 10 receives (block 500) an eCommerce transaction message containing an account identifier for a pending eCommerce transaction and initial parameter information characterizing an originating user terminal that communicated the eCommerce transaction message. The system 10 receives (block 504) from the registered user terminal a terminal authentication response message containing updated parameter information characterizing the registered user terminal. As explained above, the originating user terminal may be the same as the registered user terminal when the e-commerce transaction is generated through the account owner's user terminal. In contrast, the originating user terminal may be the fraudster's user terminal 150 when the registered user terminal is the owner's user terminal 110.

The system 10 generates the risk score for the pending eCommerce transaction based on similarity between the initial parameter information and the updated parameter information. In the example of FIG. 5, the system 10 can compare (block 504) similarity of initial sensor readings from the originating user terminal to updated sensor readings from the registered user terminal, can compare (block 506) similarity of initial hardware characteristics from the originating user terminal to updated hardware characteristics front the registered user terminal, and compare (block 508) similarity of initial software characteristics from the originating user terminal to updated software characteristics from the registered user terminal.

The system 10 then generates (block 510) a risk score for the pending eCommerce transaction based on the comparisons, and controls (block 512) authentication of the eCommerce transaction based on the risk score.

In one embodiment, the system 10 generates the risk score based on comparison of an initial measurement of a time variant characteristic, which is contained in the initial parameter information and is measured by a sensor contained in the originating user terminal, to an updated measurement of the time variant characteristic, which is contained in the updated parameter information and is measured by a sensor contained in the registered user terminal.

In another embodiment, the system 10 generates the risk score based on: 1) comparison of an initial measurement contained in the eCommerce transaction message for an elapsed time for a processor to complete execution of a defined set of operations, to an updated measurement contained in the terminal authentication response message for an elapsed time for a processor to complete execution of the defined set of operations; and/or 2) based on comparison of an initial measurement contained in the eCommerce transaction message for network communication latency to ping a defined server address through a network, to an updated measurement contained in the terminal authentication response message for network communication latency to ping the defined server address through the network. The time variant characteristic measured by a sensor may be represented by sensor orientation data and/or by camera data and/or by step counter data from a step counter.

In another embodiment, the system 10 generates the risk score based on comparison of an initial list of wireless device identifiers contained in the eCommerce transaction message to an updated initial list of wireless device identifiers contained in the terminal authentication response message. The system 10 may alternatively or additionally generate the risk score based on determining the initial parameter information characterizing the originating user terminal based on an initial list contained in the eCommerce transaction message that identifies applications presently being executed and identifies permission settings of the applications, and determining the updated parameter information characterizing the registered user terminal based on an updated list contained in the terminal authentication response message that identifies applications presently being executed and identifies permission settings of the applications.

In the further embodiment of FIG. 6, when controlling processing of the eCommerce transaction, the system 10 determines (block 600) whether the risk score satisfies a defined rule. When the determination is not satisfied the system 10 operates (block 602) to preclude authentication of a person, who is associated with the eCommerce transaction, by the authentication node 130. In contrast when the determination is satisfied the system 10 operates (block 604) to cause authentication of a person, who is associated with the eCommerce transaction, by the authentication node 130.

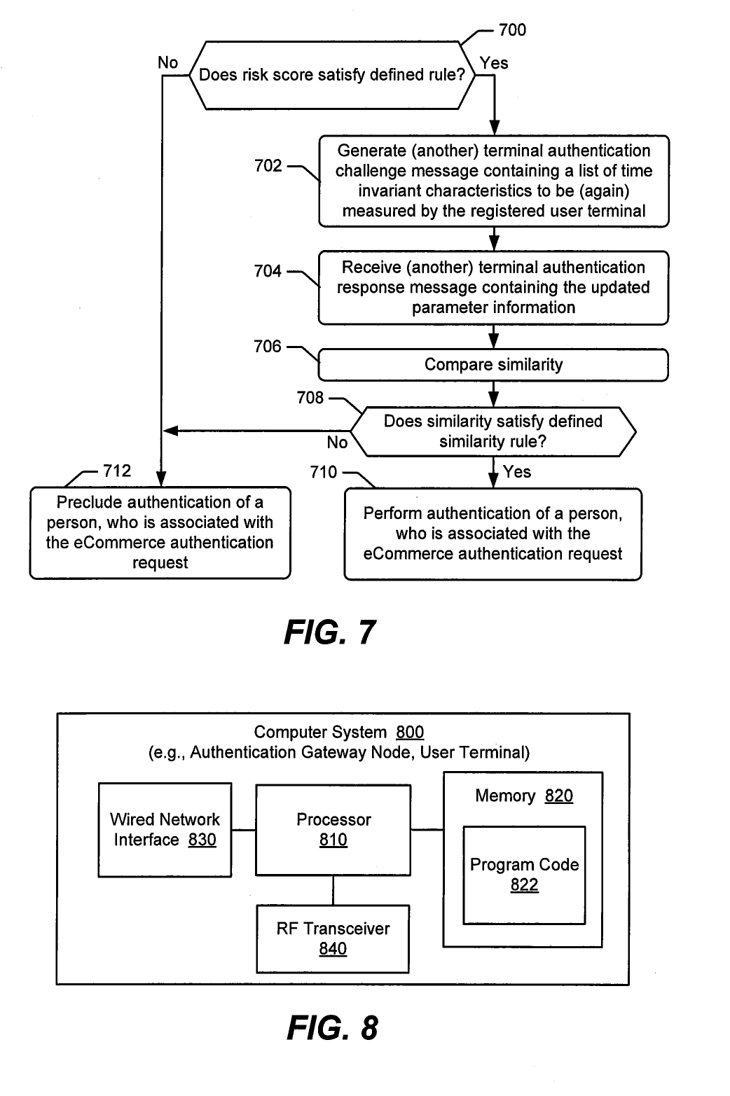

In the further embodiment of FIG. 7, the system 10 may repeat the process of obtaining parameter information from the user terminal based on determining (block 700) whether the risk score satisfies a defined rule. When the determination is not satisfied the system 10 operates (block 712) to preclude authentication of a person, who is associated with the eCommerce transaction, by the authentication node 130. In contrast when the determination is satisfied the system 10 operates to generate (block 702) a terminal authentication challenge message containing a list of time invariant characteristics to be measured by the registered user terminal, subsequently receives (block 704) a terminal authentication response message containing updated parameter information, compares (block 706) similarity of the updated parameter information to any earlier received updated parameter information and/or initial parameter information.

When the similarity is determined (block 708) to not satisfy a defined similarity rule, the system 10 operates (block 712) to preclude authentication of a person, who is associated with the eCommerce transaction. In contrast, when the similarity satisfies the similarity rule, the system 10 operates (block 710) to cause authentication of a person, who is associated with the eCommerce transaction, by the authentication node 130.

FIG. 8 is a block diagram of a computer system 800 that may be used as an authentication gateway node 100, an authentication node 130, a merchant node 120, an acquirer node 122, a user terminal 110, and/or a credit/debit finance issuer node 140 to perform the operations of one of more of the embodiments disclosed herein for one or more of those elements. The computer system 800 can include one or more network interfaces, including a wired network interface 830 and a RF transceiver interface 840. The computer system 800 further includes one or more processor circuits 810 (referred to as “processor” for brevity) and one or more memory circuits 820 (referred to as “memory” for brevity) containing program code 822.

The processor 810 may include one or more data processing circuits, such as a general purpose and/or special purpose processor (e.g., microprocessor and/or digital signal processor) that may be collocated or distributed across one or more networks. The processor 810 is configured to execute program code 822 in the memory 820, described below as a computer readable storage medium, to perform some or all of the operations for one or more of the embodiments disclosed herein.

When configured as a user terminal 110, the system 800 includes one or more radio transceivers configured to communicate with wireless devices 112 using one or more radio access technologies. The radio access technologies may include, but are not limited to, Near Field Communication (NFC), Bluetooth, WLAN (IEEE 802.11), 3GPP Long Term Evolution (LTE), etc.

### Further Definitions and Embodiments:

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
performing operations as follows on a processor of a user terminal:
responsive to initiation of an eCommerce transaction,
generating initial parameter information characterizing the user terminal, and
communicating toward a financial transaction processing system an eCommerce transaction message containing an account identifier and the initial parameter information;
responsive to receipt of a terminal authentication challenge message from the financial transaction processing system,
generating updated parameter information characterizing the user terminal, and
communicating toward the financial transaction processing system a terminal authentication response message containing the updated parameter information.

2. The method of claim 1, further comprising:
establishing an encrypted persistent IP communication connection with the financial transaction processing system, wherein the eCommerce transaction message and the terminal authentication response message are separately communicated through the encrypted persistent IP communication connection toward the financial transaction processing system, and the terminal authentication challenge message is received through the encrypted persistent IP communication connection.

3. The method of claim 1, wherein:
the generating initial parameter information characterizing the user terminal, comprises:
generating the initial parameter information based on measurement of a time variant characteristic by a sensor contained in the user terminal; and
the generating updated parameter information characterizing the user terminal based on receipt of the terminal authentication challenge message, comprises:
generating the updated parameter information based on another measurement of the time variant characteristic by the sensor contained in the user terminal.

4. The method of claim 3, wherein:
the time variant characteristic measured by the sensor contained in the user terminal is represented by physical orientation data measured by an orientation sensor in the user terminal and/or is represented by image data output by a camera in the user terminal.

5. The method of claim 3, wherein:
the time variant characteristic measured by the sensor contained in the user terminal is represented by step count data from a step counter of the user terminal.

6. The method of claim 1, wherein:
the generating initial parameter information characterizing the user terminal, comprises:
determining a hardware performance characteristic of the user terminal to generate the parameter information; and
determining a software characteristic of the user terminal,
wherein the parameter information characterizes the hardware characteristic and the software characteristic;
the generating updated parameter information characterizing the user terminal based on receipt of the terminal authentication challenge message, comprises:
repeating determination of the hardware characteristic of the user terminal; and
repeating determination of the software characteristic of the user terminal,
wherein the updated parameter information characterizes the repeated determinations of the hardware characteristic and the software characteristic;

7. The method of claim 1, wherein:
the generating initial parameter information characterizing the user terminal, comprises:
measuring an elapsed time for a processor of the user terminal to complete execution of a defined set of operations, wherein the parameter information comprises the elapsed time; and
the generating updated parameter information characterizing the user terminal based on receipt of the terminal authentication challenge message, comprises:
measuring an updated elapsed time for the processor of the user terminal to recomplete execution of the defined set of operations, wherein the updated parameter information comprises the updated elapsed time.

8. The method of claim 1, wherein:
the generating initial parameter information characterizing the user terminal, comprises:
measuring network communication latency for a communication between the user terminal and a defined server address through a network, wherein the parameter information comprises the network communication latency; and
the generating updated parameter information characterizing the user terminal based on receipt of the terminal authentication challenge message, comprises:
measuring updated network communication latency for another communication between the user terminal and the defined server address through the network, wherein the parameter information comprises the updated network communication latency.

9. The method of claim 1, wherein:
the generating initial parameter information characterizing the user terminal, comprises:
generating a list of wireless device identifiers that are observed by the user terminal, wherein the parameter information comprises the list of wireless device identifiers; and
the generating updated parameter information characterizing the user terminal based on receipt of the terminal authentication challenge message, comprises:
generating another list of wireless device identifiers that are observed by the user terminal, wherein the updated parameter information comprises the updated list of wireless device identifiers.

10. The method of claim 1, wherein:
the generating initial parameter information characterizing the user terminal, comprises:
generating a list of applications presently being executed by the user terminal, wherein the parameter information comprises the list of applications; and
the generating updated parameter information characterizing the user terminal based on receipt of the terminal authentication challenge message, comprises:
generating an updated list of applications presently being executed by the user terminal, wherein the parameter information comprises the updated list of applications.

11. The method of claim 10, wherein:
the generating initial parameter information characterizing the user terminal, further comprises:
generating a list of permission settings for the list of applications, wherein the parameter information further comprises the list of permission settings; and
the generating updated parameter information characterizing the user terminal based on receipt of the terminal authentication challenge message, further comprises:
generating an updated list of permission settings for the updated list of applications, wherein the parameter information further comprises the updated list of permission settings.

12. A method comprising:
performing operations as follows on a processor of a financial transaction processing system:
receiving an eCommerce transaction message containing an account identifier for a pending eCommerce transaction and initial parameter information characterizing an originating user terminal that communicated the eCommerce transaction message;
identifying a network address of a registered user terminal that is associated with the account identifier;
communicating toward the network address a terminal authentication challenge message containing a request for updated parameters characterizing the registered user terminal;
receiving from the registered user terminal a terminal authentication response message containing updated parameter information characterizing the registered user terminal;
generating a risk score for the pending eCommerce transaction based on similarity between the initial parameter information and the updated parameter information; and
controlling processing of the eCommerce authentication request based on the risk score.

13. The method of claim 12, wherein the controlling processing of the eCommerce authentication request based on the risk score, comprises:
controlling based on the risk score whether authentication of a purchaser who initiated the pending eCommerce transaction is performed by an authentication node.

14. The method of claim 13, wherein the generating a risk score for the pending eCommerce transaction further comprises:
generating the risk score further based on content of the eCommerce transaction message that comprises a transaction amount, an expiration date for a card associated with the account identifier, and a cardholder's name.

15. The method of claim 12, wherein the generating a risk score for the pending eCommerce transaction based on similarity between the initial parameter information and the updated parameter information, comprises:
generating the risk score based on comparison of an initial measurement of a time variant characteristic, which is contained in the initial parameter information and is measured by a sensor contained in the originating user terminal, to an updated measurement of the time variant characteristic, which is contained in the updated parameter information and is measured by a sensor contained in the registered user terminal.

16. The method of claim 15, wherein:
the time variant characteristic measured by a sensor is represented by sensor orientation data and/or is represented by camera data.

17. The method of claim 15, wherein:
the time variant characteristic measured by a sensor is represented by step counter data from a step counter.

18. The method of claim 12, wherein the generating a risk score for the pending eCommerce transaction based on similarity between the initial parameter information and the updated parameter information, comprises:
generating the risk score based on: 1) comparison of an initial measurement contained in the eCommerce transaction message for an elapsed time for a processor to complete execution of a defined set of operations, to an updated measurement contained in the terminal authentication response message for an elapsed time for a processor to complete execution of the defined set of operations; and/or 2) based on comparison of an initial measurement contained in the eCommerce transaction message for network communication latency to ping a defined server address through a network, to an updated measurement contained in the terminal authentication response message for network communication latency to ping the defined server address through the network.

19. The method of claim 12, wherein the generating a risk score for the pending eCommerce transaction based on similarity between the initial parameter information and the updated parameter information, comprises:
generating the risk score based on comparison of an initial list of wireless device identifiers contained in the eCommerce transaction message to an updated initial list of wireless device identifiers contained in the terminal authentication response message.

20. The method of claim 12, wherein the generating a risk score for the pending eCommerce transaction based on similarity between the initial parameter information and the updated parameter information, comprises:
determining the initial parameter information characterizing the originating user terminal based on an initial list contained in the eCommerce transaction message that identifies applications presently being executed and identifies permission settings of the applications; and
determining the updated parameter information characterizing the registered user terminal based on an updated list contained in the terminal authentication response message that identifies applications presently being executed and identifies permission settings of the applications.
